(19) United States
(12) Patent Application Publication
(10) Pub. No.: US 2025/0172009 A1
(43) Pub. Date: May 29, 2025

(54) Contactless (CTLS) Memorial Marker Device

(71) Applicant: ANNA GAIL WARDSWORTH, Lecompte, LA (US)

(72) Inventor: ANNA GAIL WARDSWORTH, Lecompte, LA (US)

(21) Appl. No.: 18/521,896

(22) Filed: Nov. 28, 2023

(51) Int. Cl. E04H 13/00; G06K 19/07

(52) U.S. Cl. CPC E04H 13/003; G06K 19/0723

(57) ABSTRACT

A Contactless (CTLS) Communication device for use in memorial applications includes an oval container, constructed from filament, configured to house electronic components, a CTLS chip, and associated circuitry, located within the container. This CTLS chip facilitates communication with external devices. A data storage unit for storing memorial information related to the deceased individual, and a heavy-duty mounting tape positioned on the underside of the container, being adhesive and suitable for secure attachment to tomb surfaces. The CTLS device, attached to a tomb, enables wireless communication of the stored memorial information to compatible devices within proximity, thereby providing a memorial tribute for the deceased individual.

### TECHNICAL FIELD

The Memorial Marker Device relates to a Contactless (CTLS) Communication maned device, specifically designed to facilitate secure communication and data exchange between compatible enabled devices for memorial markers.

### BACKGROUND/PROBLEM/SOLUTION

Gravesites are not just final resting places but are memorial markers to remember your loved ones. However, over the years locating the grave site may be challenging. The CTLS Memorial Marker, allows you to locate the tomb, reminisce, and enjoy fond memories of the deceased. This innovative Memorial Marker enables loved ones, friends, and strangers to connect with history and their loved one's history using CTLS technology. Therefore, what is clearly needed is a CTLS Memorial Marker device on every grave!

### SUMMARY

The CTLS Memorial Marker Device is a crafted design that allows one's family history to remain accessible to today's generation and for generations to come. It is a revolutionary device designed to pay tribute to the memory of a loved one in an innovative and enduring way. This weather-resistant and durable device serves as an outdoor memorial marker offering two main features that set it apart.

The first embodiment incorporates a Glow-in-the-Dark feature, ensuring visibility even in low light conditions. This illuminating capability not only adds a poignant touch to the memorial but also ensures that the marker remains conspicuous during nighttime visits.

The second embodiment-features a Locator function, aiding in the precise location of the marker within a cemetery or memorial park. This helpful feature alleviates the challenge of finding a specific memorial in vast outdoor spaces, enhancing the visitor experience.

The Contactless Memorial Marker Device is designed for easy installation on any flat surface, making it a versatile choice for a variety of outdoor settings. It also serves as a repository of information about the deceased person, including their photo, name, date of birth, date of passing and video presentation.

The heart of this device lies in its contactless technology, enabling effortless access to this information for anyone with a smartphone or a compatible device. Visitors can simply scan the marker, granting them instant access to the memories and details of the departed, fostering a deeper connection with their legacy.

Finally, this Contactless Memorial Marker stands as a unique and enduring way to honor the memory of loved ones, combining technological innovation with the timeless tradition of memorialization. It's glow-in-the-dark visibility and locator function ensure that cherished memories are easily accessible, making it an invaluable addition to any outdoor memorial setting. With an ornamental design and easy application and set-up, advanced CTLS technology links family and friends for years to come. Loved ones can now live forever. Just tag the key to unlock the memories!

### BRIEF DESCRIPTION OF DRAWINGS

In the following detailed portion of the present description, the teachings of the present application will be explained in more detail with reference to the example embodiments shown in the drawings, in which:

FIG. 1 is an isometric view of a device according to a first embodiment, and

FIG. 2 is an isometric view of a device according to a second embodiment.

### DETAILED DESCRIPTION

In the following detailed description, the device according to the teachings for this application in the form of a CTLS Memorial Marker will be described by the embodiments. It should be noted that although a 3-D key with oval design is described in this application, other designs may also be used in any other geometric shape or form for customization.

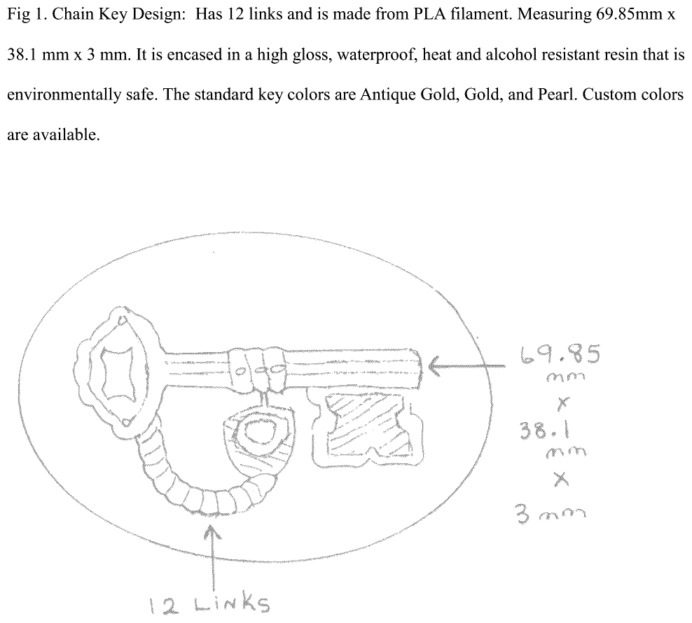

A first embodiment of the CTLS Memorial Marker 200 is illustrated in FIG. 1. The CTLS Memorial Marker is an ornamental design which is sustainably innovative. The 3D key 200 is made of an odorless Filament housed in a recyclable spool holder. The key is encased in a crystal-clear high gloss epoxy, that is a yellow resistant polymer. This High Gloss, waterproof, heat, resistant polymer does not yellow with age. The 3D key design is comprised of filament with good layer adhesion and generally requires lower printing temperatures compared to other material. It is a “Green Product” derived from renewable resources such as cornstarch or sugarcane making it biodegradable. It is considered ecofriendly compared to petroleum-based plastics. Under the right conditions, this filament can break down into natural elements, reducing environmental impact. This filament produces high-quality prints with excellent surface finish. Its' smooth appearance can accurately capture fine details, making it suitable for aesthetic or decorative objects. This filament emits minimal amounts of odor during printing as compared to others. This filament is a popular choice for 3D printing applications, including prototypes, artistic creations, educational projects and more.

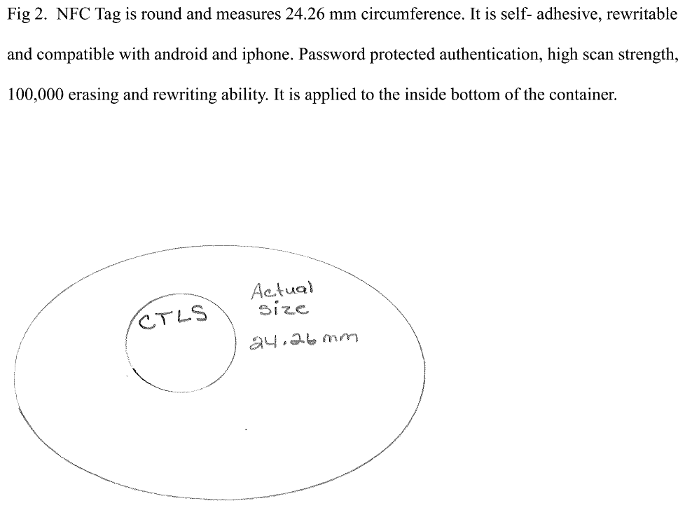

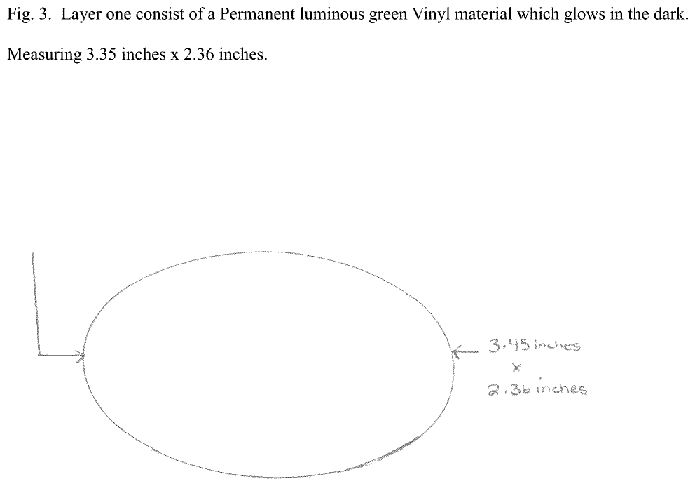

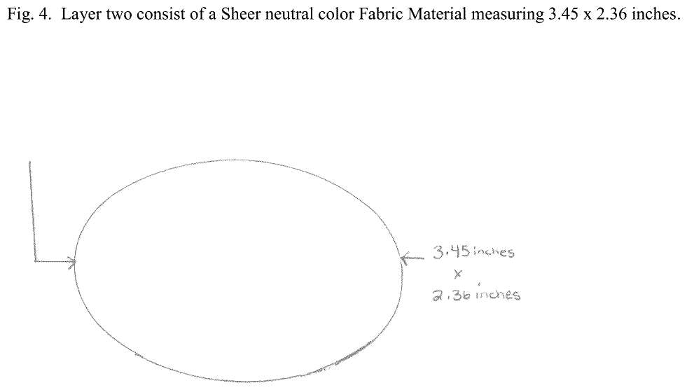

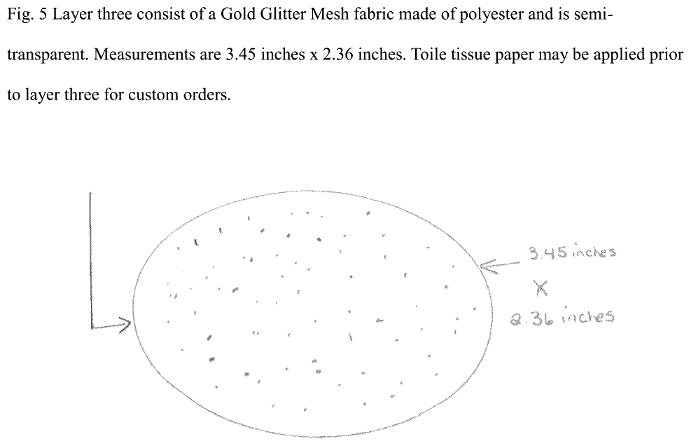

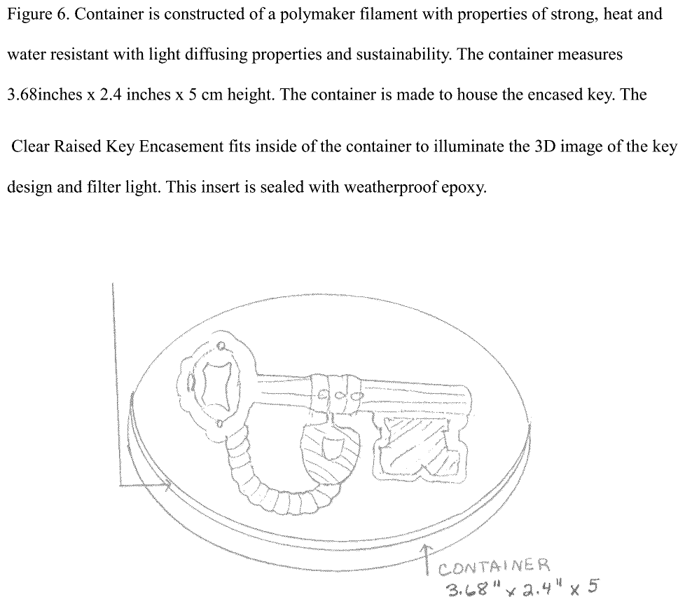

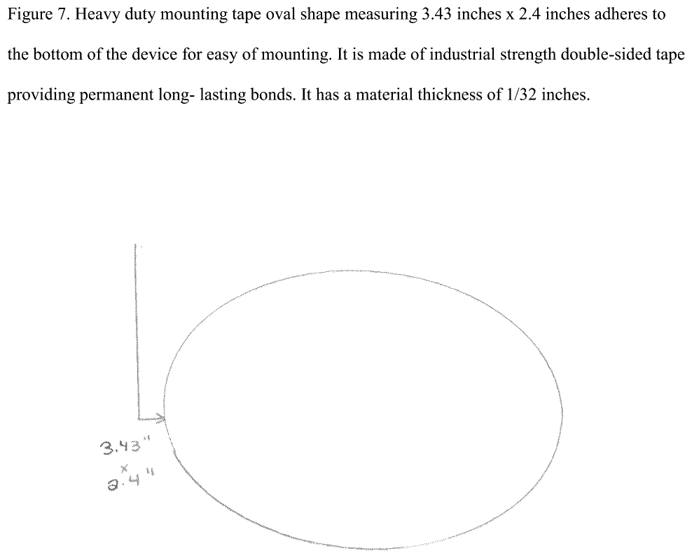

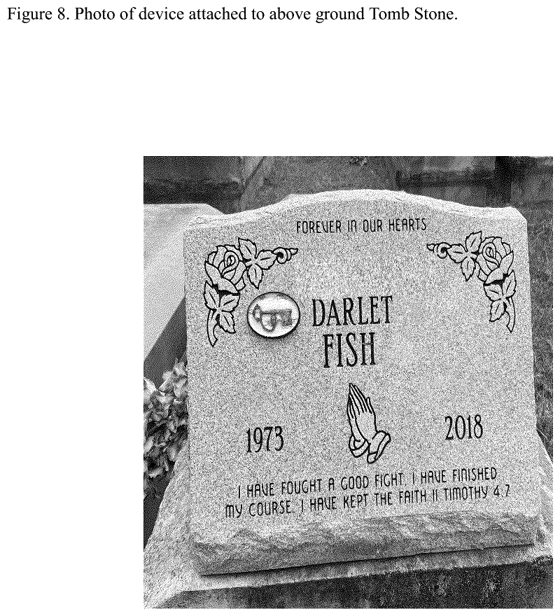

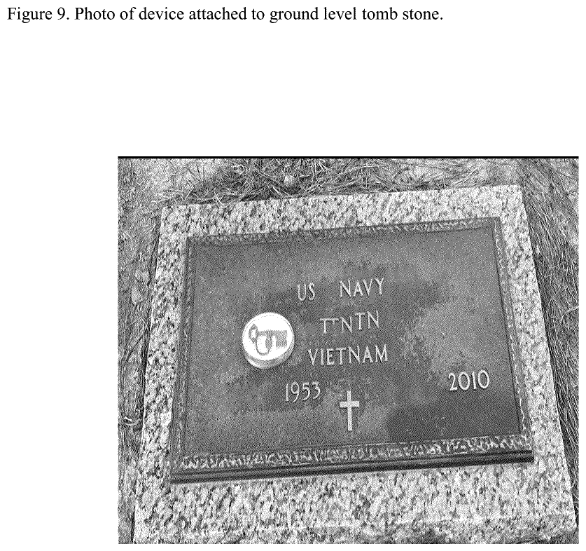

The second embodiment of the CTLS Memorial Marker container 201 is illustrated in FIG. 2.

The concave container is comprised of filament, the contactless communication micro-chip, and distinct fabrics prior to the placement of the embodiment 200. It is then sealed with krylon fusion all in one sealer gloss.

Durability. This filament is highly durable and impact resistant. It can withstand moderate stresses and is less prone to cracking or breaking compared to other filaments.

Flexibility. This filament conforms easily without breaking. This filament has good optical clarity and translucency allowing light to pass through making it useful for our glow in the dark material. This filament has a good resistance to chemicals including common solvents, acids, and bases making it suitable for applications that may involve exposure to such substances.

This filament has a relatively high glass transition temperature and can withstand moderately high temperatures without deforming or losing its structural integrity. This filament is considered food-safe, and FDA approved for direct contact with consumable items. It is widely used in the production of food containers, utensils, and packaging. These properties make this filament a versatile material suitable for a wide range of applications, including functional prototypes, mechanical parts, consumer products, and more.

Functionality. The CTLS Memorial Marker Device includes a robust water-resistant CTLS communication chip that allows it to establish near-field communication with other compatible devices. The CTLS manned device integrates advanced encryption algorithms and authenticated mechanisms, which safeguards sensitive information and prevent unauthorized access or tampering.

User Interface. 1. Purchase The CTLS Memorial Marker Device. 2. A unique activation code will be computer generated and issued to purchaser via website for immediate access to upload information to the secured site. 3. The CTLS Memorial Marker Device will be activated and mailed and/or issued to the purchaser's desired party. The Memorial Marker can be set in stone during the manufacturing process of the stone or personally applied to the headstone at the grave site. Instructions for application are present on the website and in the packaging.

The various aspects of what is described above can be used alone or in various combinations. Let it be noted that the teaching of this application is not limited to the use of the key design but can be equally applied to various 3-D designs or images. The teaching of the present application has numerous advantages. Different embodiments or implementations may yield one or more of the following advantages. It should be noted that this is not an exhaustive list and there may be other advantages which are not described herein. For example, one advantage is that the layered materials and 3-D designs may be altered for customizations. It is yet another advantage that the key colors and 3-D design colors may be altered for customization.

Although the teaching of the present application has been described in detail for purpose of illustration, it is understood that such detail is solely for that purpose, and variations can be made therein by those skilled in the art without departing from the scope of the teaching of this application. For example, the device has been described with a container that is substantially oval in shape, but it is understood that the container does not need to be oval but could have any geometrical shape. Further, the device has been described with a container that is in two pieces fashioned into one, but it should be understood the teaching can also be applied to the device with only one 3-D custom part and all devices does not have to possess the glow in the dark feature. Features described in the preceding description may be used in combinations other than the combinations categorically described.

1. A Contactless (CTLS) Communication device for use in memorial applications, comprising:
a. A concave container, constructed from filament, configured to house electronic components;
b. A clear resin glow in the dark oval topper housing a three-dimensional (3D) image placed inside said container; or single peel and stick glow in the dark key;
c. A CTLS chip and associated circuitry located within the container, said CTLS chip facilitating communication with external devices;
d. A data storage unit for storing memorial information related to the deceased individual;
e. A heavy-duty mounting tape positioned on the underside of the container, said heavy-duty mounting tape being adhesive and suitable for secure attachment to tomb surfaces;
f. Said CTLS device, when attached to a tomb, enabling wireless communication of the stored memorial information to compatible devices within proximity, thereby providing a memorial tribute for the deceased individual.
